(19) United States
(12) Patent Application Publication
(10) Pub. No.: US 2009/0101727 A1
(43) Pub. Date: Apr. 23, 2009

(54) DEHUMIDIFYING SYSTEM

(75) Inventor: Patrick Paul Boudreau, Dieppe (CA)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: AIR TECH EQUIPMENT LTD., Boudreau-Quest (CA)

(21) Appl. No.: 12/209,716

(22) Filed: Sep. 12, 2008

(30) Foreign Application Priority Data
Sep. 14, 2007 (CA) 2602737

(51) Int. Cl. G05D 22/02; G05B 15/00

(52) U.S. Cl. 236/44 C; 700/278

(57) ABSTRACT

A system providing for basement or crawlspace ventilation is described. The system allows for a reduction in the relative humidity levels of a basement or crawlspace and an increased basement or crawlspace ventilation. The basement or crawlspace ventilator includes: an inlet, duct and outlet for receiving air from the upper levels of a building and exhausting it into the basement or crawlspace of said building; a basement inlet, duct and outlet for receiving air from the basement or crawlspace and exhausting it to the outside atmosphere; an inlet, duct and outlet for transferring outside air to, and then expelling from a heat exchange core; an inlet, duct and outlet for transferring basement or crawlspace air to and from the heat exchange core; a heat exchange core used to transfer heat from the outside atmosphere to the basement or crawlspace air; and a plurality of fans for forcing ventilation from the upper levels of the building to the basement or crawlspace and from the basement or crawlspace to the outside atmosphere, from the outside atmosphere to the heat exchange core, and from the basement or crawlspace to the heat exchange core.

### BACKGROUND OF THE INVENTION

Improved construction methods and materials have resulted in buildings such as homes or other residences being much more airtight. This increasingly airtight construction has created cause for concern regarding air quality, mold and structural longevity. Humidity control is therefore a necessary consideration during the construction of new homes and during major home renovations.

### TECHNICAL FIELD

The present invention relates to a dehumidifying system. More specifically, the present invention relates to a dehumidifying system in a building.

During the summer, the moisture content of outside air is generally high. Infiltration and transfer of this humid air into a building, particularly into the basement or crawlspace, can lead to condensation, formation of mold, unwanted odors and structural damage, for example, rotting of timber. This can further lead to or worsen respiratory conditions, such as asthma, and rendering the structure unliveable.

There are existing basement or crawlspace systems commercially available which attempt to address the humidity and condensation problems. However, the prior art systems prove to be largely ineffective during long, humid periods, or the costs to maintain these systems become very high. In addition, the prior art systems also increase loads on air conditioning systems, resulting in reduced energy efficiency.

For example, while dehumidifiers provide a localized solution to humidity problems, they are costly to operate and are not advantageous with respect to air quality. Passive ventilation systems which circulate air in the basement or crawlspace area also do not solve the problems previously mentioned, given that a large difference in temperatures can still lead to condensation and the issues mentioned above.

Consequently, there is a need for a system that allows for a reduction of relative humidity levels in the crawlspace or basement area, a reduction in loads on air condition systems and increased efficiency during extended hot and humid periods.

### SUMMARY OF THE INVENTION

The present invention provides a system for controlling humidity in a cooler space, for example, in a basement or crawlspace area.

In order to reduce the relative humidity of air present in a cooler space, for example, in the basement or crawlspace, the system circulates air from the upper levels to the basement or crawlspace area. The system also exhausts basement air to the outside of the building. This is to ensure an adequate supply of fresh air from the upper levels to the basement, for air quality purposes.

The system also includes an inlet and outlet vent as well as a fan, to draw warm outside air through a heat exchange core, and to then expel the air back to the outside environment. There are also two additional interior ducts, used to draw cool basement air into the same heat exchange core, and to recirculate the warmed basement air.

The disclosed system may also have various controls for adjusting the desired basement or crawlspace humidity level and the fan speeds, for example. The system may also integrate temperature and humidity sensors. The information provided by these sensors may be used by a controller following an algorithm to determine when to change fan speed, for instance.

In accordance with one aspect of the present invention, a basement or crawlspace humidity control apparatus and system for a building is provided. The basement or crawlspace humidity control apparatus comprises:

a basement or crawlspace intake port or inlet communicating with a basement or crawlspace air path for controllably recirculating basement or crawlspace air and returning treated air to the basement or crawlspace via a basement or crawlspace air outlet port;

an outside air intake port communicating with an outside air path for controllably supplying outside air to the apparatus for heat exchange and returning said outside air to the outside via an outside air outlet port;

a basement or crawlspace air exhaust path for controllably exhausting basement or crawlspace air to the outside of the building;

an above-ground building air intake port communicating with the basement or crawlspace air path via an above-ground building air path, for controllably supplying air from one or more above-ground levels of the building to the basement or crawlspace;

at least one heat or energy exchange core communicating with the outside air path and the basement or crawlspace air path for exchanging heat between the outside air and the basement or crawlspace air to produce said treated air;

fans for at least circulating air through the outside air path and the basement or crawlspace air path; and

a controller operably linked to the fans and for controlling the fans and regulating the flows of air through the basement or crawlspace air path, the outside air path, the basement or crawlspace air exhaust path, and the above-ground building air path.

In one embodiment, air flow regulation may be fixed by the internal configuration of the dehumidification unit. In an alternate embodiment, the dehumidification unit or system may comprise stop valves or the like to facilitate the regulation or control of air flow.

In an embodiment, the controller can separately vary the air flows in each stream. In this way, the air flow in the various streams do not have to be equal.

The basement or crawlspace air supplied from the basement or crawlspace via the basement or crawlspace intake port or inlet, passes through the at least one heat or energy exchange core and is returned to the basement or crawlspace via the basement or crawlspace air outlet port. The outside air supplied from outside the building via the outside air intake port, passes through the at least one heat or energy exchange core and is returned to the outside via an outside air outlet port.

The basement or crawlspace air exhaust path allows for exhausting of at least a portion of the basement or crawlspace air to the outside of the building. In an embodiment, the basement or crawlspace air exhaust path connects to the basement or crawlspace air path at or proximal to an intake or inlet end of the at least one heat or energy exchange core, and channels a portion of the basement or crawlspace air to the outside air path, connecting to the outside air path at a return or outlet end of the at least one heat or energy exchange core thereby diverting basement or crawlspace air away from the at least one heat or energy exchange core and outside the building.

The above-ground building air intake port is capable of connecting to a source of air from the one or more above-ground levels of the building, and in an embodiment can communicate with and/or lead to the basement or crawlspace air path at or near a return or outlet end of the at least one heat or energy exchange core. In this way, the fans of the system can circulate the above-ground building air, taken either directly from the above-ground levels of the building or from the plenums of a central heating/cooling system, to the basement or crawlspace via a basement or crawlspace air outlet port.

The basement or crawlspace inlet port or intake may be a recirculation intake, and may be positioned at or near the bottom of the dehumidification unit. The outside air intake port and above-ground building air intake port may, in an embodiment, be positioned at or near the top of the dehumidification unit. Similarly, the outside air outlet port and basement or crawlspace air outlet port may, in an embodiment, be positioned at or near the top of the dehumidification unit.

It is to be understood that an above-ground level of the building may include a main or ground level, as well as any level above or higher than the main or ground level.

Preferably, the heat or energy exchange in the at least one heat or energy exchange core occurs by utilizing cross-flow of the outside air and the basement or crawlspace air through the outside air path and the basement or crawlspace air path, thus producing treated air.

The system and apparatus may further comprise temperature sensors and/or humidity sensors operably linked to the controller for providing temperature and/or humidity information required to efficiently control the fans and regulate the flows of the first air stream and the second air stream.

As part of the invention, the basement or crawlspace humidity control system comprises:

a basement or crawlspace intake communicating with a basement or crawlspace air path for controllably recirculating basement or crawlspace air and returning treated air to the basement or crawlspace via a basement or crawlspace air outlet;

an outside air intake communicating with an outside air path for controllably supplying outside air to the apparatus for heat exchange and returning said outside air to the outside via an outside air outlet;

a basement or crawlspace air exhaust path capable of controllably exhausting basement or crawlspace air to the outside of the building;

an above-ground building air intake communicating with the basement or crawlspace air path via an above-ground building air path, for controllably supplying air from one or more above-ground levels of the building to the basement or crawlspace;

at least one heat or energy exchange core communicating with the outside air path and the basement or crawlspace air path for exchanging heat between the outside air and the basement or crawlspace air to produce said treated air;

fans for at least circulating air through the outside air path and the basement or crawlspace air path; and

a controller operably linked to the fans and for controlling the fans and regulating the flows of air through the basement or crawlspace air path, the outside air path, the basement or crawlspace air exhaust path, and the above-ground building air path.

In accordance with another aspect of the present invention, there is provided a method for controlling humidity in a basement or crawlspace of a building. The method comprises:

creating a first air stream re-circulating air within a basement or crawlspace;

creating a second air stream re-circulating air from an exterior of the building back to an exterior of the building;

coordinating the first air stream with the second air stream for heat or energy exchange;

creating a third air stream directing air from an above-ground level of the building to the basement or crawlspace; and

creating a fourth air stream exhausting air from the basement or crawlspace to the exterior of the building;

wherein the second air stream is recirculated and coordinated with the first air stream for heat exchange if the air temperature at the exterior of the building is higher than the temperature of the basement or crawlspace air.

The method preferably comprises steps of measuring humidity and/or temperature of the air from the exterior of the building, the air from the above-ground level of the building, and the air from the basement or crawlspace.

Preferably the flow of air in at least one of the first, second, third and fourth air streams is controllable. In an embodiment, the flow of air is controlled based on the humidity and/or temperature of the air from the exterior of the building and the air from the above-ground level of the building. In a preferred embodiment, the flow of air in the second air stream is reduced or stopped if the temperature of the air from the exterior of the building is lower than the temperature of the basement or crawlspace air. In a further preferred embodiment, the flow of air in the third air stream is reduced or stopped if the humidity of the air from the above-ground level of the building is higher than the humidity of the basement or crawlspace air. In another preferred embodiment, the flow of air in the first and/or fourth air streams is reduced or stopped if the humidity of the air from the above-ground level of the building is higher than the humidity of the basement or crawlspace air, the temperature of the air from the exterior of the building is lower than the temperature of the basement or crawlspace air, or both.

Accordingly, the method may further comprise the steps of: comparing the temperature of the air from the exterior of the building with the temperature of the basement or crawlspace air; comparing the humidity or dewpoint of the air from the above-ground level of the building with the humidity or dewpoint of the basement or crawlspace air; and controlling the rates of recirculation and exhaust of the basement or crawlspace air, and the rates of ingress of the air from the exterior of the building and the above-ground level of the building, based on predetermined threshold values for said comparisons.

In certain embodiments, the controller can be programmed to compare dew point along with humidity and temperature to facilitate efficient operation of the system. For example, the controller may be programmed to lower the fan speed if it detects that, over time, the air from the above-ground level of the building will not help in drying out the basement or crawlspace. In a further possible embodiment, the controller can be programmed to use successive comparisons of the temperature, humidity and dew point values over a given amount of time to optimize the system operation.

In an embodiment, the rate of ingress of the air from the exterior of the building is minimized when the temperature of the air from the exterior of the building is below a predetermined minimum temperature and/or below the temperature of the air in the basement or crawlspace.

In an embodiment, the rate of ingress of the air from the exterior of the building is maximized when the temperature of the air from the exterior of the building is above a predetermined minimum temperature and/or above the temperature of the air in the basement or crawlspace.

In an embodiment, the rate of ingress of the air from the above-ground level of the building is minimized when the humidity of the air from the above-ground level of the building is above a predetermined maximum humidity and/or above the humidity of the air in the basement or crawlspace.

In an embodiment, the rate of ingress of the air from the above-ground level of the building is maximized when the humidity of the air from the above-ground level of the building is below a predetermined maximum humidity and/or below the humidity of the air in the basement or crawlspace.

In an embodiment, the rates of recirculation and exhaust of the basement or crawlspace air are maximized if the rate of ingress of the air from the exterior of the building and/or the rate of ingress of the air from the above-ground level of the building is maximized.

In an embodiment, the rates of recirculation and exhaust of the basement or crawlspace air are minimized if the rate of ingress of the air from the exterior of the building and/or the rate of ingress of the air from the above-ground level of the building is minimized.

Preferably, the heat or energy exchange occurs by utilizing cross-flow of the first air stream and the second air stream.

### BRIEF DESCRIPTION OF THE DRAWINGS

The present invention, in terms of a preferred embodiment, is illustrated in the attached drawings, wherein:

FIG. 1 shows a diagram of a basement or crawlspace ventilator indicating one embodiment of the present invention;

FIG. 2 shows a diagram of a basement or crawlspace ventilator indicating a second embodiment of the present invention;

FIG. 3 shows a flowchart of an exemplary process for controlling the system in accordance with the embodiment of the present invention;

FIG. 4 is a view of an example of the interior of a dehumidification unit according to an embodiment of the system and method of the present invention;

FIG. 5 is a top perspective view the dehumidification unit shown in FIG. 4, shown with the front panel of the unit removed;

FIG. 6 is a view of an example of a heat exchange core according to one possible embodiment of the invention;

FIG. 7 is a schematic representation of the dehumidification unit shown in FIG. 4, illustrating an example of the placement of sensors and fans and air flows through the unit; and

FIG. 8 is a cross-sectional view of a magnetic gasket in accordance with an embodiment of the invention.

### DESCRIPTION OF PREFERRED EMBODIMENTS OF THE INVENTION

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention pertains.

The term “duct” is intended to include any conduit, passage, pipe, tube or other elongated hollow body capable of carrying air. A duct may be formed by any type of suitable duct material, for example but not limited to, sheet metal, plastic, or the like.

The term “fan” is intended to include any instrument or device for producing a current of air, for example but not limited to, any device that comprises a series of vanes radiating from a hub rotated on its axle by a motor.

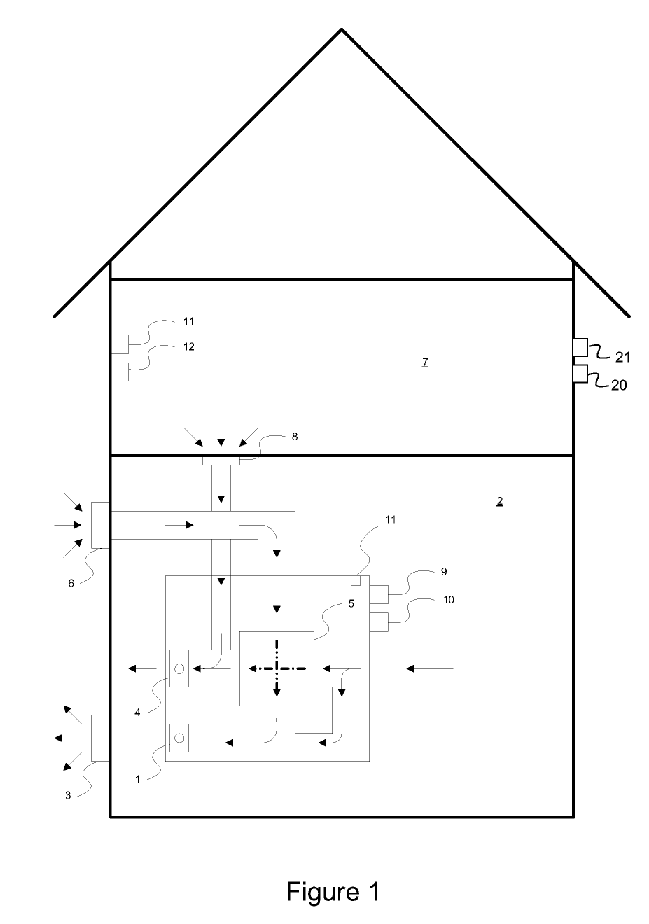

FIG. 1 shows a possible embodiment of the system described. The dehumidification system includes a fan 1, used to circulate warm, outside air, through a duct 6 to a heat exchange core 5 and also to expel stale, humid air from the basement or crawlspace to the outside environment, through another duct 3. In addition, a second fan 4 circulates humid basement/crawlspace air through the heat exchange core 5, and also draws air from the upper level 7 of the structure through a duct 8 to the basement or crawlspace 2. The heat exchange core 5 transfers heat, but not moisture, from the hot, humid outside air to the air being circulated in the basement or crawlspace 2. This results in a lower relative humidity in the basement or crawlspace 2, thus a lower dew point.

Humidity sensors 9, 11 and temperature sensors 10, 12 are incorporated into the dehumidification system, allowing for the measurement of the basement or crawlspace's relative humidity and temperature levels, and the outside air, thus allowing for an efficient operation of the system. In addition, the system may comprise humidity and temperature sensors 20, 21 to detect the outside temperature and humidity, for instance, placed directly outside the building as shown in FIG. 1 or alternatively inside the dehumidification unit in the air stream coming from outside. The humidity sensor 9, 11, 20 and temperature sensor 10, 12, 21 data is collected by a microprocessor 8, which can be used to determine the appropriate fan speeds and adjust the system's fans as required. This allows the microprocessor 8 to determine whether it is causing an unnecessary or undesirable heat, humidity or energy loss based on the conditions in the upper 7 and lower levels 2 of the building, and to adjust its operation in response. One skilled in the art will also appreciate that data collected from a temperature and a humidity sensor will allow for calculation of the dew point, and as such this parameter may be calculated and monitored by the system together with the temperature and a humidity data.

It is be understood that the location of the sensors within the system or unit can be varied. For example, the outside temperature and humidity sensors can either be physically outside the building, or in the dehumidification unit or system in the airstream coming from outside. Similarly, the temperature and humidity sensors in the basement or crawlspace and in the above-ground building levels can either be located appropriately within the building, or in the dehumidification unit or system in the airstreams coming from the basement or crawlspace and the above-ground building levels.

The basement or crawlspace dehumidification system may also comprise a dehumidistat used to specify the desired relative humidity of the basement or crawlspace 2. The relative humidity is transmitted to the microprocessor 8 and the system's fan speeds can be adjusted as needed.

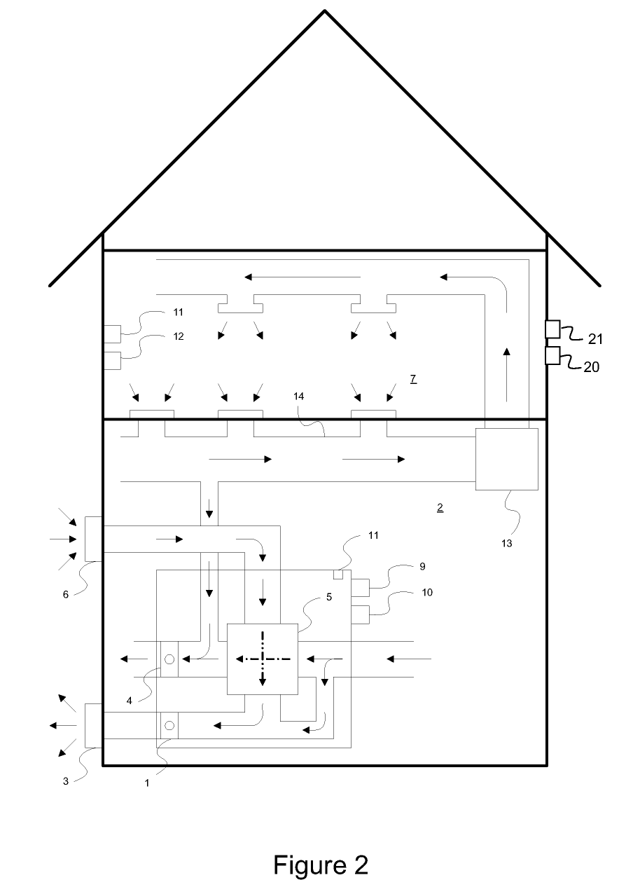

An example of a second embodiment of the basement or crawlspace dehumidification system is shown in FIG. 2, where air is drawn from plenums used by a central air conditioning system 13, for example. Any central heating/cooling system may be used as the source of air from the upper level(s) of the building.

In this figure, a fan 1 circulates outside air through a duct 6 into a heat exchange core 5, and back into the outside environment through a second duct 3. The air exiting the air exchange core 5 is in this case mixed with stale, humid air from the basement or crawlspace 2 before being exhausted. A second fan 4 draws basement or crawlspace air through the heat exchange core 5, thus warming it and reducing its relative humidity, and circulating it back into the basement or crawlspace. This dehumidified air is mixed with air drawn from the central air conditioning exhaust plenum 14, providing fresh air to the basement or crawlspace 2.

Again, humidity sensors 9, 11, 20 and temperature sensors 10, 12, 21 can be used to determine the humidity levels of either the air in the upper 7 and lower levels 2 of the building, or the outside air. This data, fed to a microprocessor 8, can be used to determine the necessary fan speeds and allows for the maximization of the efficiency of the system.

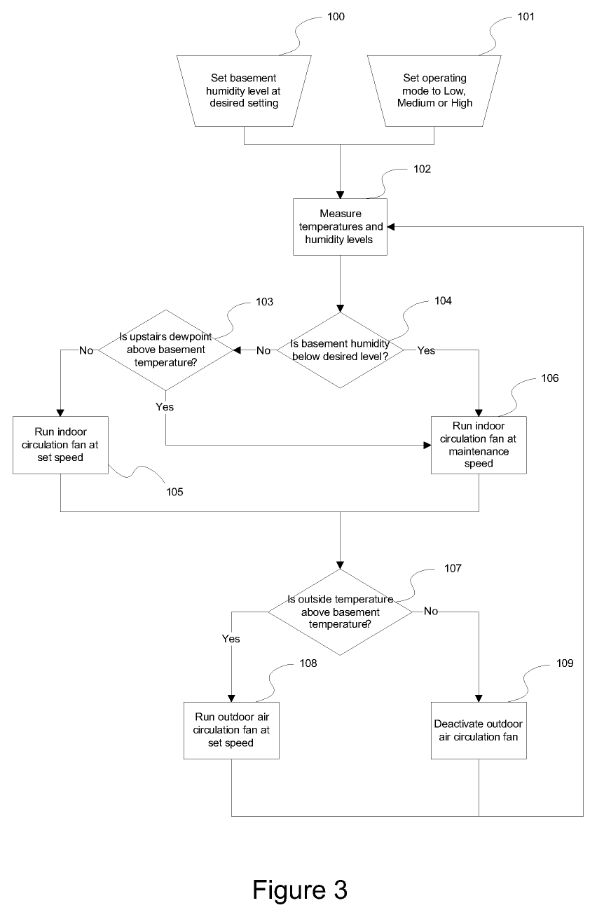

FIG. 3 shows a flowchart of an example of a process for controlling the disclosed system. Initially, the user sets a desired humidity level using the system's dehumidistat 100, and selects a fan speed 101. The process could be modified without changing the nature of the invention.

The system measures the upstairs and basement temperatures and humidity levels, as well as the temperature of the outside air 102. If the basement humidity level is below the desired level 104, or if the upstairs air dewpoint is above the basement temperature 103, then the fan circulating air from the upstairs to the basement and from the basement to the outdoors is run in a standby mode 106. If the basement humidity level is above the desired relative humidity level, then the fan is run at the speed specified by the homeowner 105.

If the outside temperature is warmer than the basement or crawlspace temperature 107, then the fan circulating the outside air through the heat exchange core is run at the speed specified by the homeowner 108. If the outside temperature is below the basement or crawlspace temperature, then the fan circulating outside air through the heat exchange core is deactivated 109. At this point, the process continues as described in the previous paragraph, at point 102.

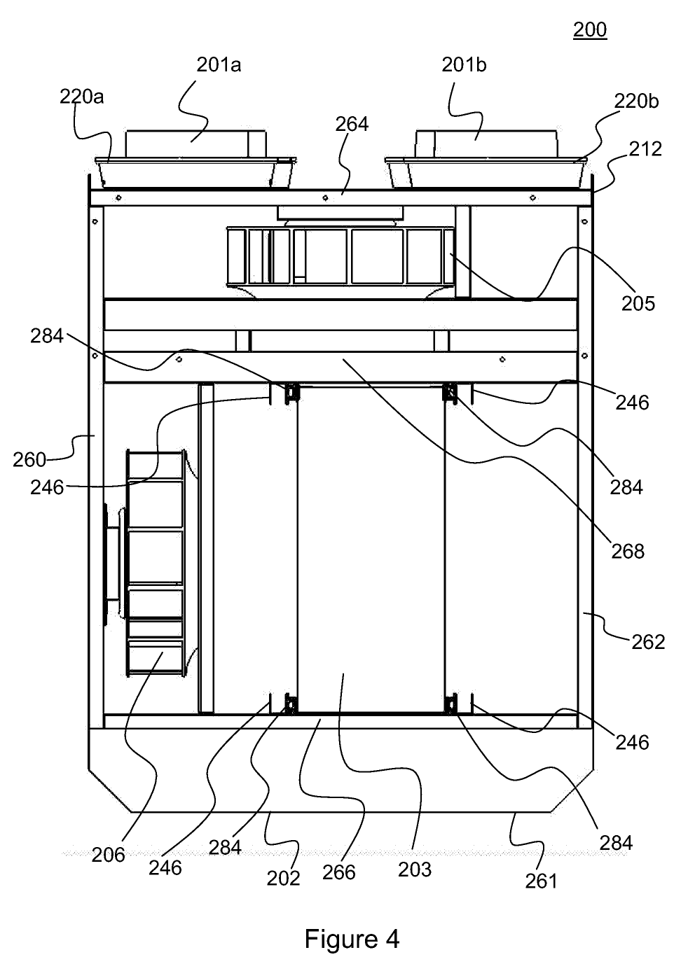

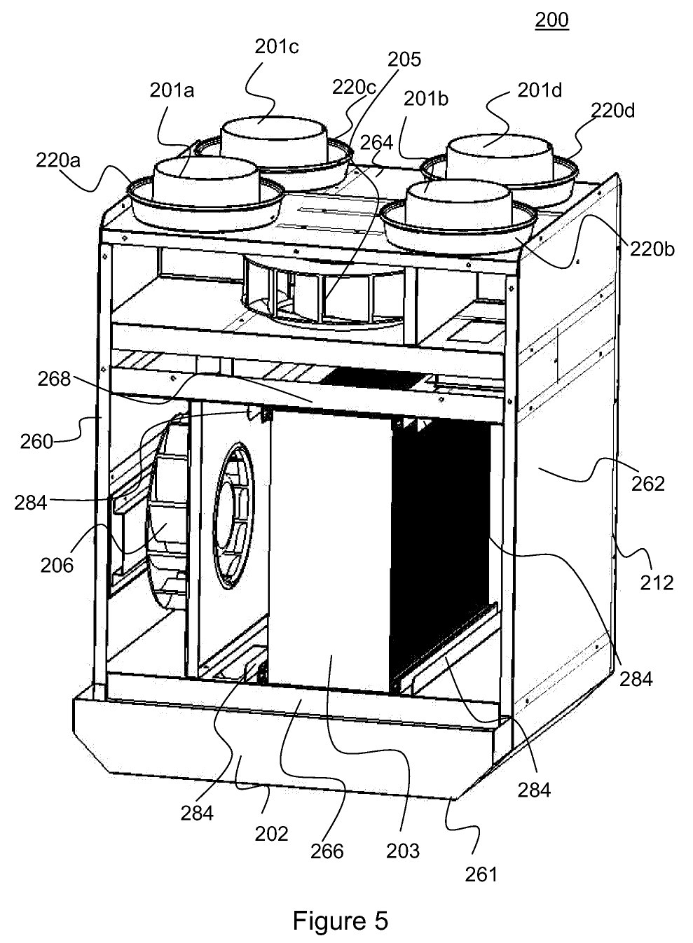

An exemplary embodiment of a dehumidification unit for use in the system and method of the present invention is illustrated in FIGS. 4 and 5.

The dehumidification unit comprises a housing 212 which includes a pair of side walls 260, 262, a rear wall, a top wall 264, a bottom wall 261, as well as a bottom horizontal core support 266 and a top horizontal core support 268 which hold at least one heat exchange or energy recovery core 203. The housing 212 also includes a removable front panel (removed in FIGS. 4 and 5 to show the unit interior). Core supports 284 releasably hold the core 203 in place.

It can be appreciated that the housing may releaseably hold one core or may releasably hold a plurality of cores without departing from the scope of the invention. Additionally, it can be appreciated that the housing may be adapted to releaseably hold different types of cores, including exchangers and sub-cores, of varying types and construction, for instance, made of plastic, aluminium or any other material. As an example, heat exchange cores or enthalpy exchange cores as described in International PCT publication number WO2007/051286, or both, may be used as the ‘core’ as described herein.

Insulation layers, such as foam interlays, may optionally be used to cover inner surfaces of the housing 212 to provide both thermal and acoustic insulation. Additionally, filters may be provided, for example, adjacent port 201d, to filter the outside air supply before flowing into the core 203.

In the embodiment depicted in FIGS. 4 to 6, the core is cuboid, for example, in the shape of a cube or rectangular prism, and has substantially straight perimeter edges. The core 203 is sized and configured to nest substantially adjacent to one or more interior walls of the housing 212, as depicted, the top and bottom horizontal core supports 268 and 266 respectively, and core supports 284. The core is dimensioned so as to facilitate placement of the core within the housing, but also to permit certain perimeter edges adjacent to the interior walls to be located proximately thereto so as to reduce or minimize the size of gaps therebetween through which air flow may pass.

Support means 246, for example, rails, brackets, plates, strips, formed ridges, ledges, or guides, or the like are provided within the housing 212 to assist in the positioning and retention of the core 203 in the housing 212. Preferably, the support means are sized and shaped so as to contact the core along perimeter edges to minimize obstruction to airflow through the core. A pair of support means 246 may be positioned on the top horizontal core support 268 to position and retain a top end of core 203 within housing 12 and a pair of support means 246 are positioned on the bottom horizontal core supports 266 to position and retain a bottom end of core 203. Such support means preferably extend fully from the rear wall to the removable front panel, and is substantially air impermeable to reduce the amount of leakage of air flow between the core and an adjacent interior wall of the housing 212. It can be appreciated that the number of such support means, if provided, and the placement thereof within the housing may vary based upon the number of cores used, the shape thereof, their positioning and their orientation within the housing. Support means, if present, may be provided to support perimeter edges of a core adjacent and proximate to an inner wall surface of the housing. Support means 246 can also be used to install a filter before and/or after the core. Accordingly, filters can be placed near the port 201d, as specified above, and/or right next to the core using support means 246.

Alternatively, panels provided with knock outs or other openings may be used to retain and position the cores. Such panels may be similar to the top and bottom horizontal core supports 268 and 266. Such panels may be positioned perpendicular to and vertical relative to the top and bottom horizontal core supports 268 and 266. Such panels may be permanently affixed or slidably retained within the housing 212.

The housing 212 includes a plurality of variously placed ports 201a-d, each of which having a connector 220a-d connectable to various ducts. In the embodiment shown, the unit 200 has four ports 201a-d positioned on the top surface of the unit. In addition, an intake cover or grill 202 is located at or near the bottom of the unit and which covers a recirculation intake.

The recirculation intake is where air from the basement or crawlspace enters the unit. It is to be noted that the stalest and dampest air in a building is normally found in the basement or crawlspace in proximity to the basement/crawlspace floor. By drawing the stale and damp air found proximate the floor and exhausting it to the atmosphere outside the building, basement humidity can be substantially reduced, and mold and mildew development can be reduced or even eliminated. Accordingly, the closer the recirculation intake is positioned to the floor, the greater the efficiency in removing humidity from the basement or crawlspace. However, the unit will still function with the recirculation intake positioned halfway to the basement or crawlspace ceiling or even closer.

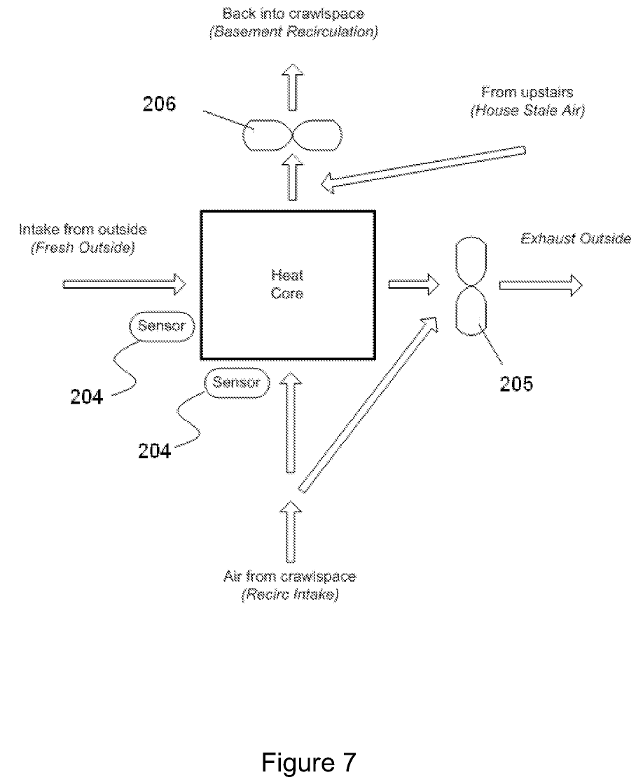

Air from outside the house is drawn into the unit 200 via the fresh/outside air port 201d and through a heat exchange core 203 by at least one fan, such as first fan 205. Air from the main or upper floors of the house is drawn into the unit via the house stale air port 201b by at least one fan, such as second fan 206, where it is to be recirculated into the basement or crawlspace. Outside air which is drawn into the unit, as well as a portion of the basement or crawlspace air, is directed outside via the exhaust outside port 201c. Air that is recirculated back into the basement or crawlspace passes through the heat exchange core 203 and is vented through the basement/crawlspace recirculation port 201a. The flow of air through the unit is illustrated in detail in the schematic illustration provided in FIG. 7.

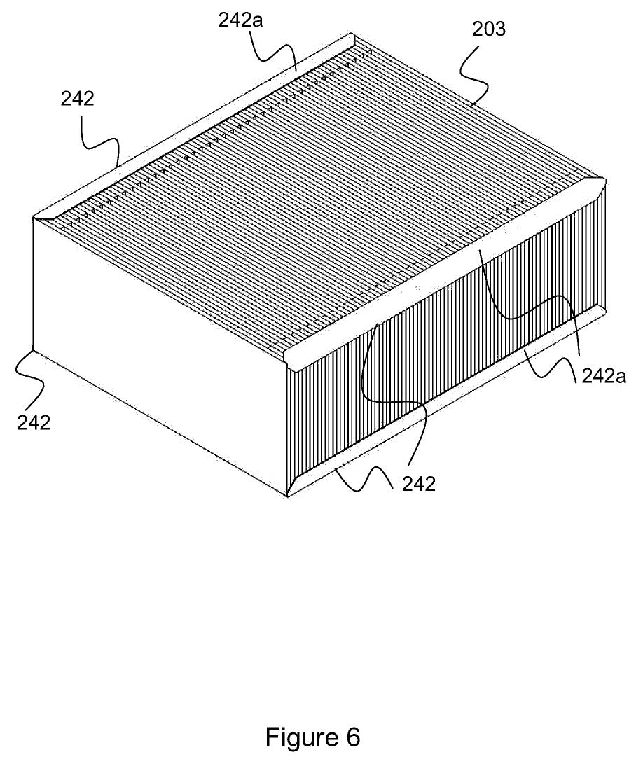

The heat exchange core 203, shown separate from unit 200 in FIG. 6, exchanges heat between the outside air and the basement or crawlspace (recirculated) air. The core is provided with four rails 242, strips, tracks or the like (collectively termed “rails” for ease) preferably positioned along perimeter edges of the core 203 which, when positioned within the housing 212, are perpendicular to the direction of the airflows and are adjacent the support means. The rails are provided with a contact surface 242a. The rails are preferably formed from magnetisable metals or magnetic metal alloys, preferably ferromagnetic materials, more preferably ferromagnetic materials of high magnetic permeability. These metal rails may be attached to the core 203 using an adhesive sealant or other suitable fastening means. Additional sealant may be used to prevent air leakage. Preferably, the rails are L-shaped.

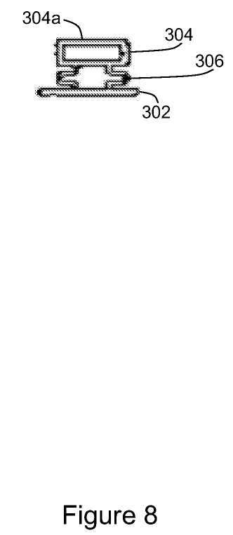

Gaskets may be provided on support means 246. Such gaskets may be magnetic gaskets having a permanent magnet, each having a base portion for attachment to a support means. In an embodiment, as shown in FIG. 8 an elongated tube 304 is attached to the base portion 302 by way of a resilient web 306. The web 306 is deformable upon compression of the tube 304 toward the base 302. Preferably, the tube 304, web 306 and base 302 are formed from a polymeric or elastomeric material. Preferably, the base is conformable to contact surfaces, for example, on support means or directly on interior walls of the housing, that may be irregular or uneven. Preferably, the tube 304 and web 306 are compressible and conformable against a contact surface of a rail 242 so as to form a removable and yet substantially air impermeable seal.

In cross-section, the elongated tube 304 may be rectangular in outline, shaped and sized to receive permanent magnets therein. The contact surface 304a of the tube 304 may be substantially flat and providing a sealing surface. Alternatively, the contact surface of the tube 304a may be mildly convex, providing a further deformable contact surface and thereby may provide a tighter seal when in contact with the contact surface 242a of a rail 242.

Alternatively, the elongated tube may be in the form of an elongated, tubular bead, with a convex contact surface. In cross-section, the tubular bead may form an oval, semi-circle, circle, or the like. Depending on the design and the application, the web 304 may not be necessary, particularly if additional resilience and compressibility is not required.

Permanent magnets may be inserted within the tube 304 or in the bead. The magnet may be flexible, for example, formed from a composite magnetic powder or granules with a polymeric or elastomeric binder, for example, PVC. The magnet may be a strip magnet, and may further be a multiple magnet for magnetic attraction in the direction of the contact surface of the gasket tube 204. The magnet may be a replaceable insert.

The magnetic gaskets may be secured to the support rails in alignment with the metal rails 242 provided on the core 203 so as to magnetically contact and cooperate with the metal rails on the cores and thereby form an air tight seal.

The permanent magnet is selected to be of sufficient magnetic strength to form a seal with the metal rail.

To minimize leakage and contamination, the magnetic gaskets should be in contact with the metal rails 242 along the full length of the edge of the core 203, as depicted in FIGS. 4 and 5, and is preferably of unitary construction of sufficient length. Failure to do so may reduce the effectiveness of the seals and may lead to increased leakage and cross-contamination of airflows in the ventilation system.

Alternatively, the base portion 302 of the gasket may be mounted directly to housing at positions corresponding to the location and placement of the cores, for example, at positions on the top or bottom horizontal core supports 268 or 266. The base 302 may be attached by a variety of means including sealants, adhesives and fasteners.

Alternatively, the support means 246 may be provided with grooves or tracks for receiving complementary projections such as a boss, guide, dart, ridge, plates, or the like, provided on the underside of the base 302. Such corresponding grooves and projections may be mated, sized and shaped for retaining engagement of the gasket to the support means.

Alternatively, the support means 246 may be provided with a channel for receiving a complementary shaped base 302.

Alternatively, grooves, tracks or channels may be provided directly at positions on the top or bottom horizontal core supports 268 or 266, for receiving complementary or mated projections provided on the base 302 or for receiving a complementary shaped base, for retaining engagement of the gasket to the housing 212.

As a further alternative, the metal railings on the energy core 203 may be a permanent magnet. Instead of magnetic gaskets, the railing magnet may be aligned with and paired with a gaskets similar to that depicted in FIG. 8, but instead of a permanent magnet, the gasket may be provided with a magnetisable material within the tube 304. Such metal railings may be of flexible construction, or comprise powders or granules formed into a composite. Preferably, the materials comprise a ferromagnetic material, and more preferably a ferromagnetic material of high magnetic permeability. Alternatively, the contact surface of the gasket may be a composite comprising a magnetisable material, including ferromagnetic material, bound together with polymeric or elastomeric binders. In such a case, on alignment of magnet railings exerting sufficient magnetic force with such a gasket will effect magnetic attraction drawing the contact surface of the gasket to sealingly engage the magnet railings and form a seal.

The gaskets and corresponding rails 242 on the perimeter edges of core 203 may be positioned so as to form an air tight seal between the core 203 and the adjacent walls (for example, top 268, bottom 266, rear wall and front panel) where air leakage may occur. It may be unnecessary to provide gaskets along perimeter edges of the core where air leakage is minimal or unlikely to occur, for example, due to additional insulation or sealant on the rear wall and front panel.

As depicted in FIGS. 4 and 5, a core 203 has been placed within housing 212. The metal rails 242, as depicted in FIG. 6 are aligned with corresponding magnetic gaskets located on the support rails 246. Magnetic attractive forces in the magnetic gaskets form an air tight seal with the metal rails of the cores, thereby reducing the amount of leakage and contamination between the supply air flow and the return air flow through the dehumidification unit. Upon exerting sufficient force to overcome the magnetic attractive force between the magnetic gasket and the correspondingly aligned metal rails, the energy core 203 may be removed for maintenance, repair or replacement, as necessary.

Referring again to FIG. 7, the unit 200 may include temperature/humidity sensors 204 appropriately positioned to measure the temperature and humidity of the outside and basement/crawlspace air, and which are monitored by electronic controllers to detect when the unit should be operating. For example, if the outside temperature is greater than the temperature in the crawlspace, the unit will bring outside air through the heat exchange core 203 and some of this heat will be transferred to the air being recirculated into the basement or crawlspace. Gradually, this will increase the overall temperature of the air in the crawlspace. At the point where the outside air is cooler than the crawlspace air, the unit can automatically switch to a lower speed (to keep minimal airflows) and will preferably remain in this mode until the difference between the outside air and the inside air is significant to increase the speed.

The unit can be provided with a controlling system which includes an electronic dehumidistat, for instance, a dehumidistat with a speed setting switch (e.g. three positions) and a knob that can be used to set the desired humidity level. The electronic dehumidistat may also have an LCD display, showing the current humidity level.

In an embodiment, the LCD display can be adapted to show detected humidity levels when the unit is powered on. The LCD display can also be adapted to indicate when the dehumidistat has been triggered. When the dehumidistat is in the triggered mode, the unit will operate at a determined speed, e.g, a speed determined by a speed setting switch. The LCD display can also be adapted to indicate when the dehumidistat is not triggered. When the dehumidistat is not triggered, the fan speed will preferably be set to a low speed to keep a minimal level of airflow.

While particular embodiments of the present invention have been shown and described, changes and modifications may be made to such embodiments without departing from the true scope of the invention, as would be apparent to one of skill in the art.

What is claimed is:

1. A basement or crawlspace humidity control apparatus comprising:
a basement or crawlspace intake port or inlet communicating with a basement or crawlspace air path for controllably recirculating basement or crawlspace air and returning treated air to the basement or crawlspace via a basement or crawlspace air outlet port;
an outside air intake port communicating with an outside air path for controllably supplying outside air to the apparatus for heat exchange and returning said outside air to the outside via an outside air outlet port;
a basement or crawlspace air exhaust path for controllably exhausting basement or crawlspace air to the outside of the building;
an above-ground building air intake port communicating with the basement or crawlspace air path via an above-ground building air path, for controllably supplying air from one or more above-ground levels of the building to the basement or crawlspace;
at least one heat or energy exchange core communicating with the outside air path and the basement or crawlspace air path for exchanging heat between the outside air and the basement or crawlspace air to produce said treated air;
fans for at least circulating air through the outside air path and the basement or crawlspace air path; and
a controller operably linked to the fans and for controlling the fans and regulating the flows of air through the basement or crawlspace air path, the outside air path, the basement or crawlspace air exhaust path, and the above-ground building air path.

2. The basement or crawlspace humidity control apparatus according to claim 1, wherein the basement or crawlspace air exhaust path joins the basement or crawlspace air path to the outside air path and is for controllably diverting the basement or crawlspace air away from the at least one heat or energy exchange core and to the outside of the building.

3. The basement or crawlspace humidity control apparatus according to claim 1, wherein the above-ground building air path joins the basement or crawlspace air path for controllably supplying air from one or more above-ground levels of the building to the basement or crawlspace via the basement or crawlspace air outlet port.

4. The basement or crawlspace humidity control apparatus according to claim 1, wherein the basement or crawlspace intake port or inlet is a recirculation intake positioned at or near the bottom of the apparatus.

5. The basement or crawlspace humidity control apparatus according to claim 1, wherein the outside air intake port, above-ground building air intake port, the outside air outlet port, the basement or crawlspace air outlet port, or combinations thereof, are positioned at or near the top of the apparatus.

6. The basement or crawlspace humidity control apparatus according to claim 1, wherein the heat or energy exchange in the at least one heat or energy exchange core occurs by utilizing cross-flow of the outside air and the basement or crawlspace air through the outside air path and the basement or crawlspace air path to produce said treated air.

7. The basement or crawlspace humidity control apparatus according to claim 1, further comprising temperature sensors and/or humidity sensors operably linked to the controller for providing temperature and/or humidity information to efficiently control the fans and regulate the flows of air through the basement or crawlspace air path, the outside air path, the basement or crawlspace air exhaust path, and the above-ground building air path.

8. A basement or crawlspace humidity control system for a building comprising:
a basement or crawlspace intake communicating with a basement or crawlspace air path for controllably recirculating basement or crawlspace air and returning treated air to the basement or crawlspace via a basement or crawlspace air outlet;
an outside air intake communicating with an outside air path for controllably supplying outside air to the apparatus for heat exchange and returning said outside air to the outside via an outside air outlet;
a basement or crawlspace air exhaust path capable of controllably exhausting basement or crawlspace air to the outside of the building;
an above-ground building air intake communicating with the basement or crawlspace air path via an above-ground building air path, for controllably supplying air from one or more above-ground levels of the building to the basement or crawlspace;
at least one heat or energy exchange core communicating with the outside air path and the basement or crawlspace air path for exchanging heat between the outside air and the basement or crawlspace air to produce said treated air;
fans for at least circulating air through the outside air path and the basement or crawlspace air path; and
a controller operably linked to the fans and for controlling the fans and regulating the flows of air through the basement or crawlspace air path, the outside air path, the basement or crawlspace air exhaust path, and the above-ground building air path.

9. The basement or crawlspace humidity control system according to claim 8, wherein the basement or crawlspace air exhaust path joins the basement or crawlspace air path to the outside air path and controllably diverts the basement or crawlspace air away from the at least one heat or energy exchange core and to the outside of the building.

10. The basement or crawlspace humidity control system according to claim 8, wherein the above-ground building air path joins the basement or crawlspace air path and controllably supplies air from one or more above-ground levels of the building to the basement or crawlspace via the basement or crawlspace air outlet.

11. The basement or crawlspace humidity control system according to claim 8, wherein the basement or crawlspace intake is a recirculation intake positioned at or near a floor of the basement or crawlspace.

12. The basement or crawlspace humidity control system according to claim 8, wherein the heat or energy exchange in the at least one heat or energy exchange core occurs by utilizing cross-flow of the outside air and the basement or crawlspace air through the outside air path and the basement or crawlspace air path to produce said treated air.

13. The basement or crawlspace humidity control system according to claim 8, further comprising temperature sensors and/or humidity sensors operably linked to the controller for providing temperature and/or humidity information to efficiently control the fans and regulate the flows of air through the basement or crawlspace air path, the outside air path, the basement or crawlspace air exhaust path, and the above-ground building air path.

14. A method for controlling humidity in a basement or crawlspace of a building, the method comprising:
creating a first air stream re-circulating air within a basement or crawlspace;
creating a second air stream re-circulating air from an exterior of the building back to an exterior of the building;
coordinating the first air stream with the second air stream for heat or energy exchange;
creating a third air stream directing air from an above-ground level of the building to the basement or crawlspace; and
creating a fourth air stream exhausting air from the basement or crawlspace to the exterior of the building;
wherein the second air stream is recirculated and coordinated with the first air stream for heat exchange if the air temperature at the exterior of the building is higher than the temperature of the basement or crawlspace air.

15. The method according to claim 14, further comprising measuring humidity and/or temperature of the air from the exterior of the building, the air from the above-ground level of the building, and the air from the basement or crawlspace.

16. The method according to claim 15, further comprising:
comparing the temperature of the air from the exterior of the building with the temperature of the basement or crawlspace air;
comparing the humidity and/or dewpoint of the air from the above-ground level of the building with the humidity and/or dewpoint of the basement or crawlspace air; and
controlling rates of recirculation and exhaust of the basement or crawlspace air, and rates of ingress of the air from the exterior of the building and the above-ground level of the building, based on predetermined threshold values for said comparisons.

17. The method according to claim 16, wherein the rate of ingress of the air from the exterior of the building is minimized when the temperature of the air from the exterior of the building is below a predetermined minimum temperature and/or below the temperature of the air in the basement or crawlspace.

18. The method according to claim 16, wherein the rate of ingress of the air from the exterior of the building is maximized when the temperature of the air from the exterior of the building is above a predetermined minimum temperature and/or above the temperature of the air in the basement or crawlspace.

19. The method according to claim 16, wherein the rate of ingress of the air from the above-ground level of the building is minimized when the humidity of the air from the above-ground level of the building is above a predetermined maximum humidity and/or above the humidity of the air in the basement or crawlspace.

20. The method according to claim 16, wherein the rate of ingress of the air from the above-ground level of the building is maximized when the humidity of the air from the above-ground level of the building is below a predetermined maximum humidity and/or below the humidity of the air in the basement or crawlspace.

21. The method according to claim 16, wherein the rates of recirculation and exhaust of the basement or crawlspace air are maximized if the rate of ingress of the air from the exterior of the building and/or the rate of ingress of the air from the above-ground level of the building is maximized.

22. The method according to claim 16, wherein the rates of recirculation and exhaust of the basement or crawlspace air are minimized if the rate of ingress of the air from the exterior of the building and/or the rate of ingress of the air from the above-ground level of the building is minimized.

23. The method according to claim 14, wherein the heat or energy exchange occurs by utilizing cross-flow of the first air stream and the second air stream.
